(19) United States
(12) Patent Application Publication
(10) Pub. No.: US 2018/0190145 A1
(43) Pub. Date: Jul. 5, 2018

(54) WORK SUPPORT DEVICE, WORK SUPPORT METHOD, AND COMPUTER PROGRAM PRODUCT

(71) Applicant: KABUSHIKI KAISHA TOSHIBA, Tokyo (JP)

(72) Inventors: Kanako NAKAYAMA, Tokyo (JP); Kazunori IMOTO, Kawasaki (JP); Sawa FUKE, Kawasaki (JP); Yasuyuki TSUNOI, Tokorozawa (JP)

(73) Assignee: KABUSHIKI KAISHA TOSHIBA, Tokyo (JP)

(21) Appl. No.: 15/690,796

(22) Filed: Aug. 30, 2017

(30) Foreign Application Priority Data
Jan. 5, 2017 (JP) 2017-000303

(51) Int. Cl. G09B 19/00; G09B 5/02; H04N 7/18; G06Q 10/06

(52) U.S. Cl. CPC G09B 19/003; G06Q 10/06398; H04N 7/183; G09B 5/02

(57) ABSTRACT

According to an embodiment, a work support device includes a memory and processing circuitry. The processing circuitry is configured to function as a work segment generating unit and a display control unit. The work segment generating unit generates a plurality of work segments including one or more work elements out of a plurality of work elements classified based on any one or a plurality of attributes of a work object, a work position, a part to be used, and a tool to be used. The display control unit controls display of segment display information corresponding to the work segments.

### CROSS-REFERENCE TO RELATED APPLICATIONS

This application is based upon and claims the benefit of priority from Japanese Patent Application No. 2017-000303, filed on Jan. 5, 2017; the entire contents of which are incorporated herein by reference.

### FIELD

Embodiments described herein relate generally to a work support device, a work support method, and a computer program product.

### BACKGROUND

In production sites that deal with a small quantity and a large variety of products, for example, necessary work varies depending on the products. As a result, workers frequently proceed with work while referring to documents, such as drawings, without determining a detailed work process in advance. In such production sites, it may possibly take a long time to refer to the documents, check the work, and select the next work, thereby reducing the work efficiency. To address this, there is a need for a work support mechanism that enables workers to efficiently proceed with work even in production sites having no definite work procedure.

### BRIEF DESCRIPTION OF THE DRAWINGS

FIG. 1 is a block diagram illustrating an exemplary configuration of a work support device according to a first embodiment;

FIG. 2 is a diagram for explaining an example of drawing data of a distribution board serving as a work area;

FIG. 3 is a diagram illustrating an example of work element data;

FIG. 4 is a diagram illustrating an example of work segments;

FIG. 5 is a diagram illustrating an example of work segment data;

FIG. 6 is a diagram illustrating a display example of segment display information;

FIG. 7 is a diagram illustrating another display example of the segment display information;

FIG. 8 is a diagram illustrating still another display example of the segment display information;

FIG. 9 is a diagram illustrating still another display example of the segment display information;

FIG. 10 is a block diagram illustrating an exemplary configuration of the work support device according to a modification of the first embodiment;

FIG. 11 is a diagram illustrating an example of a selection screen;

FIG. 12 is a block diagram illustrating an exemplary configuration of the work support device according to a second embodiment;

FIG. 13 is a diagram illustrating an example of the work segment data;

FIG. 14 is a diagram illustrating a display example of the segment display information;

FIG. 15 is a diagram illustrating another display example of the segment display information;

FIG. 16 is a block diagram illustrating an exemplary configuration of the work support device according to a modification of the second embodiment;

FIG. 17 is a diagram illustrating an arrangement example of a camera;

FIG. 18 is a diagram illustrating another arrangement example of the camera;

FIG. 19 is a diagram illustrating a display example of the segment display information; and

FIG. 20 is a block diagram illustrating an exemplary configuration of the work support device according to a third embodiment.

### DETAILED DESCRIPTION

According to an embodiment, a work support device includes a memory and processing circuitry. The processing circuitry is configured to function as a work segment generating unit and a display control unit. The work segment generating unit generates a plurality of work segments including one or more work elements out of a plurality of work elements classified based on any one or a plurality of attributes of a work object, a work position, a part to be used, or a tool to be used. The display control unit controls display of segment display information corresponding to the work segments.

A work support device, a work support method, and a computer program product according to embodiments support work performed by workers such that they can efficiently proceed with the work while grasping the entire picture of the work in production sites that deal with a small quantity and a large variety of products and have no definite detailed work procedure, for example.

With recent progress in digitization of documents, such as drawings, production sites that produce various products have been equipped for providing a variety of work support using information processing technologies. In production sites having a detailed work procedure determined in advance, a digitized work procedure is stored in advance and presented in accordance with the percentage of completion of work performed by workers for navigation.

In production sites having no definite detailed work procedure, a work unit (referred to as a “work segment” in the embodiments) that facilitates workers' performing work is estimated using digitized data on individual work (referred to as a “work element” in the embodiments) performed on a certain product. By recognizing the work segment, the workers can efficiently proceed with the work.

The embodiments generate work segments that facilitate workers' grasping the entire picture of work and grasping the relation between pieces of the work, and display segment display information that visualizes the work segments, thereby supporting the work performed by the workers. The work element indicates individual work, such as “screw tightening” and “wiring”, and has information, such as “work object”, “work position”, “part to be used”, and “tool to be used”, which are attributes. The work segment is an aggregate of a plurality of work elements and is generated by classifying the work elements based on their attributes.

The work support device, the work support method, and the computer program product according to the embodiments are described below in greater detail with reference to the accompanying drawings. In the description below, components having the same function are denoted by like reference numerals, and overlapping explanation thereof is appropriately omitted.

### First Embodiment

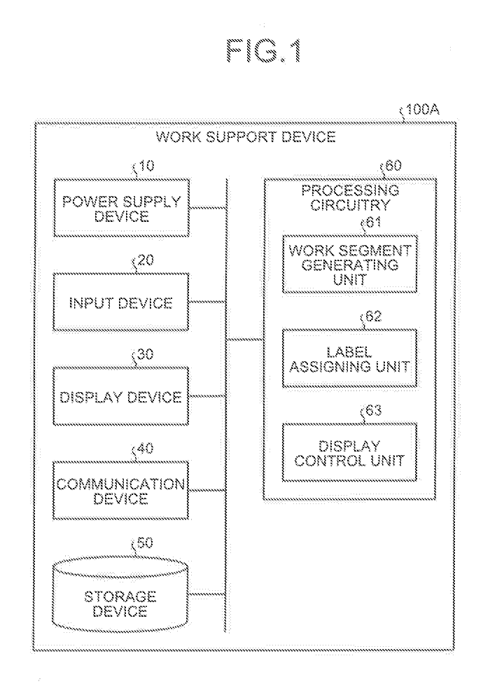

FIG. 1 is a block diagram illustrating an exemplary configuration of a work support device 100A according to a first embodiment. The work support device 100A according to the present embodiment, for example, is hardware of a mobile electronic device (computer), such as a tablet computer and a smartphone. The work support device 100A is used by a worker who performs work in a production site. As illustrated in FIG. 1, the work support device 100A includes a power supply device 10, an input device 20, a display device 30, a communication device 40, a storage device 50, and processing circuitry 60.

The power supply device 10 supplies electric power to the work support device 100A and is a chargeable and dischargeable storage cell (battery), for example.

The input device 20 is used to perform an input operation by the worker who uses the work support device 100A and is a touch panel or an operation button, for example. In a case where the work support device 100A is provided with software that performs speech recognition, the input device 20 may be a microphone that receives speech of the worker.

The display device 30 displays various types of information to the worker who uses the work support device 100A and is a liquid crystal display, for example.

The communication device 40 enables the work support device 100A to communicate with an external device and is a wireless communication module for Wireless Fidelity (Wi-Fi) or Bluetooth (registered trademark), for example.

The storage device 50 stores therein computer programs executed by she processing circuitry 60, various types of data, and the like as needed. The storage device 50 includes a semiconductor memory, such as a random access memory (RAM) and a flash memory, a hard disk, or an optical disc as a storage medium, for example. The storage device 50 according to the present embodiment stores therein digitized drawing data, work element data referred to by the processing circuitry 60, and work segment data generated by the processing circuitry 60, for example.

The processing circuitry 60 includes a processor, such as a central processing unit (CPU) and a graphical processing unit (GPU). The processing circuitry 60 causes the processor to execute the computer programs read from the storage device 50, for example, thereby providing functional components including a work segment generating unit 61, a label assigning unit 62, and a display control unit 63 illustrated in FIG. 1. The functional components may be provided not by the general-purpose processor, such as the CPU and the GPU, executing the computer programs, but by dedicated hardware, such as an application specific integrated circuit (ASIC) and a field programmable gate array (FPGA). Furthermore, the functional components may be provided by a plurality of processors in a distributed manner.

The work segment generating unit 61 refers to the work element data stored in the storage device 50. The work segment generating unit 61 classifies a plurality of work elements based on any one or a plurality of attributes of a work object, a work position, a part to be used, or a tool to be used, thereby generating a plurality of work segments each including one or more work elements. The work segment generating unit 61 stores the work segment data indicating the generated work segments in the storage device 50. The work element data and the work segment data will be described later in greater detail.

The label assigning unit 62 assigns labels to the respective work segments generated by the work segment generating unit 61. The label assigning unit 62 refers to the work element data and the work segment data stored in the storage device 50, thereby determining the similarity between the work segments based on the attributes or the work elements included in the work segments generated by the work segment generating unit 61. The label assigning unit 62 assigns a common label to similar work segments.

The display control unit 63 controls display of segment display information corresponding to the work segments generated by the work segment generating unit 61. The segment display information visualizes the work segments generated by the work segment generating unit 61 and includes figures, characters, and symbols indicating the ranges of the work segments, for example. The display control unit 63, for example, causes the display device 30 to display an image obtained by superimposing the segment display information on the drawing data stored in the storage device 50. The display control unit 63 causes the display device 30 to display the segment display information than enables the worker to recognize the difference between the labels assigned to the respective work segments by the label assigning unit 62. The display control unit 63, for example, causes the display device 30 to display the segment display information having different display forms of colors and line types of figures varying depending on the labels. A specific example of the segment display information will be described later in greater detail.

The following describes a specific example of processing performed by the work segment generating unit 61, the label assigning unit 62, and the display control unit 63 with reference to work performed in a production site for distribution boards, which are an example of a small quantity and a large variety of products. In the description below, a “work area” indicates an area (area on a distribution board in the present example) within a range where individual work (work element) for a certain product is performed.

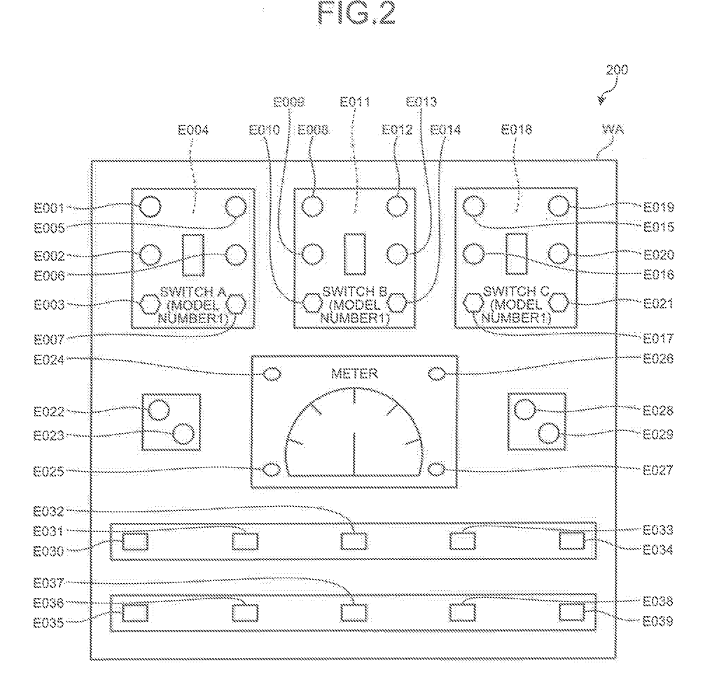

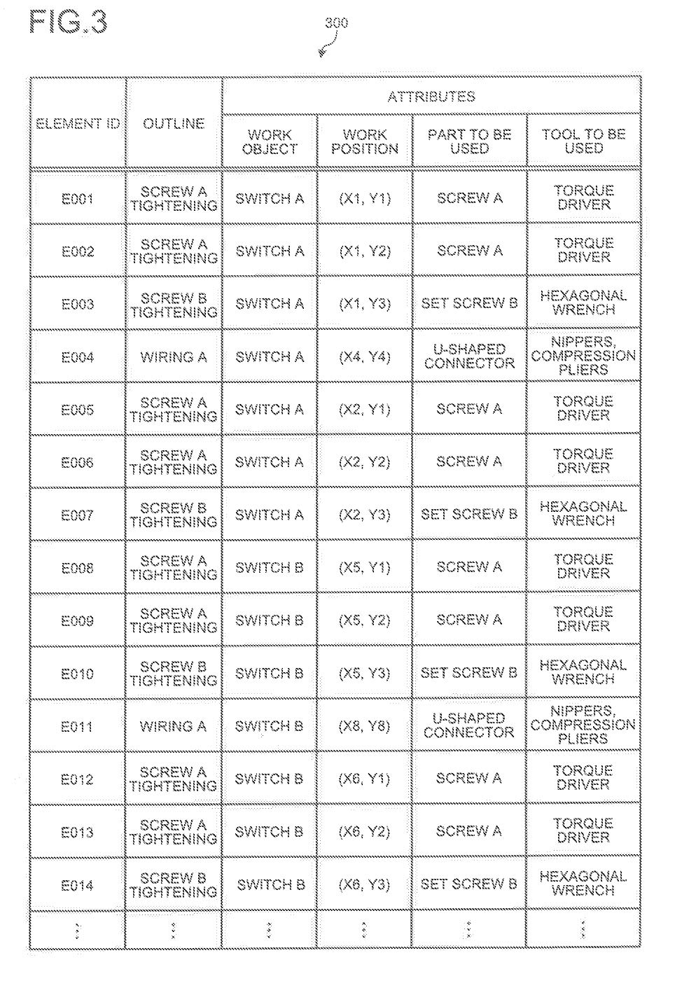

FIG. 2 is a diagram illustrating an example of drawing data 200 of a distribution board serving as a work area. FIG. 3 is a diagram illustrating an example of work element data 300 corresponding to the drawing data 200 illustrated in FIG. 2. As illustrated in FIGS. 2 and 3, work performed on one work area (distribution board in the present example) WA includes a plurality of work elements. Information on the work elements are stored in the storage device 50 as the work element data 300. In FIG. 2, element IDs for identifying the respective work elements are used as reference numerals for descriptive purposes to indicate the respective work elements in the work area WA.

As illustrated in FIG. 3, for example, the work element data 300 has a form in which an individual work element is associated with an element ID for identifying the work element, an outline of the work element, and attributes of the work element. While the attributes of the work element is “work object”, “work position”, “part to be used”, and “tool to be used” in the example illustrated in FIG. 3, the attributes may be any one or a combination of any two or three of them. The values of the attributes are not limited to general terms illustrated in FIG. 3 and may be special terms (jargon), symbols, or the like used in the production site.

The work element data 300 is generated in advance as a set of data for each work area and stored in the storage device 50. FIG. 3 illustrates part of the work element data 300 corresponding to the drawing data 200 illustrated in FIG. 2. The work element data 300 may be generated by manual input. Alternatively, the work element data 300 may be automatically created by associating symbols and character information in the digitized document, such as the drawing data 200, with the item values in the work element data 300 in advance.

The work segment generating unit 61 refers to the work element data 300 illustrated in FIG. 3. The work segment generating unit 61 classifies a plurality of work elements included in the work area WA based on any of the attributes to generate a plurality of work segments. The work segment generating unit 61 stores the work segment data indicating the generated work segments in the storage device 50.

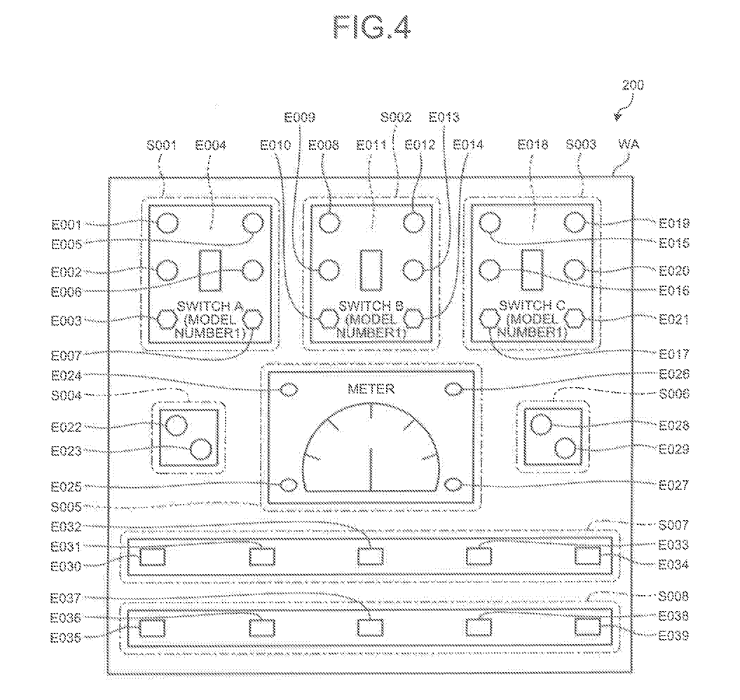

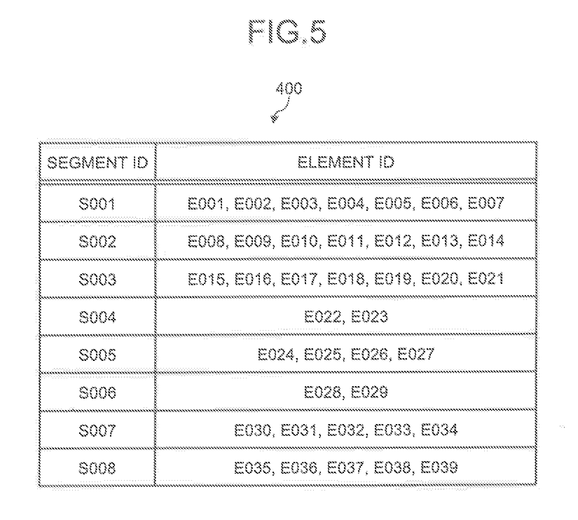

FIG. 4 is a diagram illustrating an example of the work segments generated using “work object” out of the attributes of the work elements. FIG. 5 is a diagram illustrating an example of work segment data 400 corresponding to the work segments illustrated in FIG. 4. FIG. 4 illustrates the work segments on the drawing data 200 identical with that illustrated in FIG. 2. In FIG. 4, segment IDs for identifying the respective work segments are used as reference numerals for descriptive purposes to indicate the respective work segments.

To generate the work segments using “work object”, the work segment generating unit 61 classifies the work elements such that work elements having the same “work object” belong to one work segment, thereby generating the work segments. In FIG. 4, for example, the work segment generating unit 61 classifies work elements E001, E002, E003, E004, E005, E006, and E007 having “work object” of a switch A into one work segment, thereby generating a work segment S001.

As illustrated in FIG. 5, for example, the work segment data 400 has a form in which a generated work segment is associated with a segment ID for identifying the work segment and elements ID of work elements included in the work segment. The work segment data 400 may include not only the segment ID and the element ID but also other information, such as various types of information useful for displaying the segment display information.

The label assigning unit 62 assigns labels based on the similarity between the work segments to the work segments generated using “work object”. In other words, the label assigning unit 62 assigns a common label to similar work segments. In the example illustrated in FIG. 4, the label assigning unit 62 assigns a common label to the work segments S001, S002, and S003, a common label to the work segments S004 and S006, and a common label to the work segments S007 and S008. The similarity between the work segments is determined using the attributes of the work elements included in the work segments. The label assigning unit 62, for example, may determine work segments having the same model number of “work object” to be the similar work segments. Alternatively, the label assigning unit 62 may classify, by a clustering method, information obtained by converting the number and the attributes of the work elements in the work segments into numerical values, thereby determining work segments classified into the same class to be the similar work segments.

The display control unit 63 refers to the work segment data 400 illustrated in FIG. 5 and the work element data 300 illustrated in FIG. 3. The display control unit 63 causes the display device 30 to display the segment display information that visualizes the work segments generated by the work segment generating unit 61 in such a manner that the worker can recognize the difference between the labels assigned to the respective work segments.

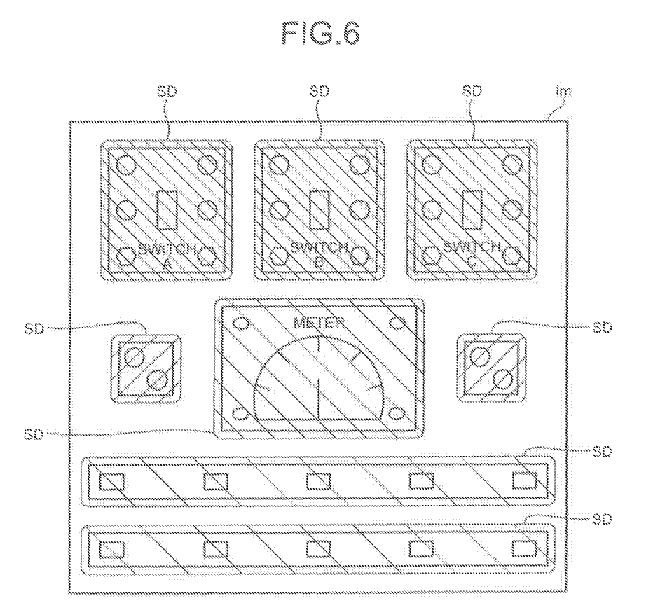

FIG. 6 is a diagram illustrating a display example of segment display information SD. As illustrated in FIG. 6, for example, the display control unit 63 superimposes the segment display information SD corresponding to the work segments generated by the work segment generating unit 61 on the drawing data, thereby generating a display image Im. The display control unit 63 performs control such that the display device 30 displays the display image Im. In the example illustrated in FIG. 6, the segment display information SD corresponding to the work segments generated by the work segment generating unit 61 is superimposed on the drawing data as figures indicating the ranges of the respective work segments on the drawing data. The work segments to which a common label is assigned by the label assigning unit 62 have the figures of the segment display information SD in the same color, for example. On the drawing, the difference in color between the figures of the segment display information SD is represented by the difference in types of hatching.

The segment display information SD simply needs to be displayed in such a manner that the worker who refers to the display device 30 can recognize the work segments, and the display method is not limited to the example illustrated in FIG. 6. The display control unit 63, for example, may display one segment display information SD using characters, symbols, and the like besides or instead of the figures illustrated in FIG. 6. To use characters and symbols in the segment display information SD, the display control unit 63 may use the values of the attributes of the work elements used to generate the work segments or certain characters and symbols indicating the characteristics of the work segments. The display control unit 63 may superimpose characters and symbols varying depending on the work segments on the positions of the respective work elements, thereby generating the segment display information SD.

The method for causing the worker to recognize the difference between the labels assigned to one work segments is not limited to the difference in color of the segment display information SD. Alternatively, another method for causing the worker to visually recognize the difference may be used, such as difference in line types or patterns. While the segment display information SD is superimposed and displayed on the drawing data in the example illustrated in FIG. 6, the display control unit 63 may superimpose the segment display information on the work element data 300 illustrated in FIG. 3, for example, and cause the display device 30 to display the work element data 300.

As described in the example above, if the work segments are generated using “work object” out of the attributes of the work elements, and a common label is assigned to the similar work segments, the work segments to which the common label is assigned correspond to repetition of the same work. The present embodiment displays the segment display information SD corresponding to the work segments in such a manner that the worker can recognize the difference between the labels of the respective work segments. Consequently, the worker who refers to the segment display information SD can grasp the groups of the same work while grasping the entire picture of the work, thereby efficiently proceeding with the work.

Besides “work object”, the attributes of the work elements used to generate the work segments may be “work position”, a combination of “work object” and “part to be used” or “tool to be used”, and a combination of “work position” and “part to be used” or “tool to be used”, for example.

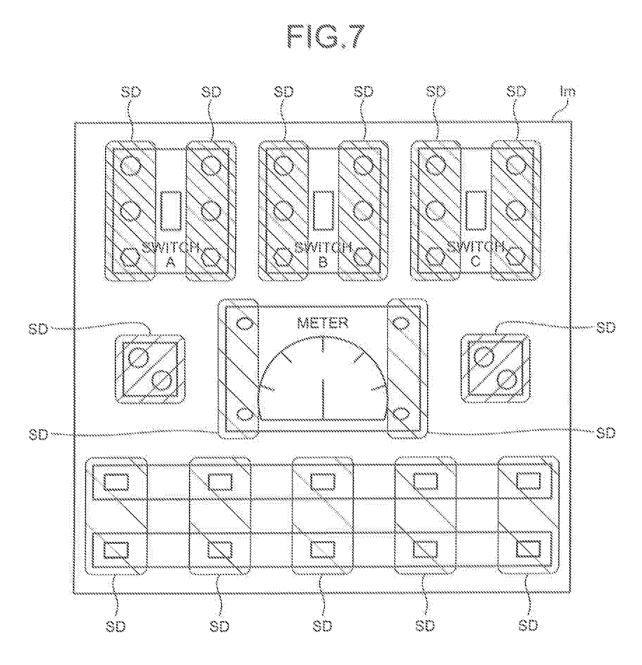

FIG. 7 is a diagram illustrating a display example of the segment display information SD in a case where the work segment generating unit 61 generates the work segments using “work position” out of the attributes of the work elements.

To generate the work segments using “work position”, the work segment generating unit 61 classifies the work elements such that work elements having “work position” close to each other belong to one work segment, thereby generating the work segments. The work segment generating unit 61, for example, calculates the distance between the work elements based on “work position”. The work segment generating unit 61 determines a group of work elements the distance between which is equal to or smaller than a predetermined threshold to be one work segment. Alternatively, the work segment generating unit 61 classifies “work position” by the clustering method and determines work elements belonging to the same class to be one work segment. The work segment generating unit 61 thus generates the work segments based on “work position”.

The label assigning unit 62 assigns labels based on the similarity between the work segments to the work segments generated using “work position”. In other words, the label assigning unit 62 assigns a common label to similar work segments. The similarity is determined by a method of determining work segments including work elements having the same “part to be used” or “tool to be used” to the similar work segments, for example.

As illustrated in FIG. 7, for example, the display control unit 63 superimposes the segment display information SD corresponding to the work segments generated by the work segment generating unit 61 on the drawing data, thereby generating the display image Im. The display control unit 63 performs control such that the display device 30 displays the display image Im. The segment display information SD superimposed on the drawing data enables the worker to recognize the difference between the labels by the difference in color, for example.

As described above, also in the case where the work segments are generated using “work position” out of the attributes of the work elements, and a common label is assigned to the similar work segments, the worker who refers to the segment display information SD can grasp the groups of the same work while grasping the entire picture of the work, thereby efficiently proceeding with the work.

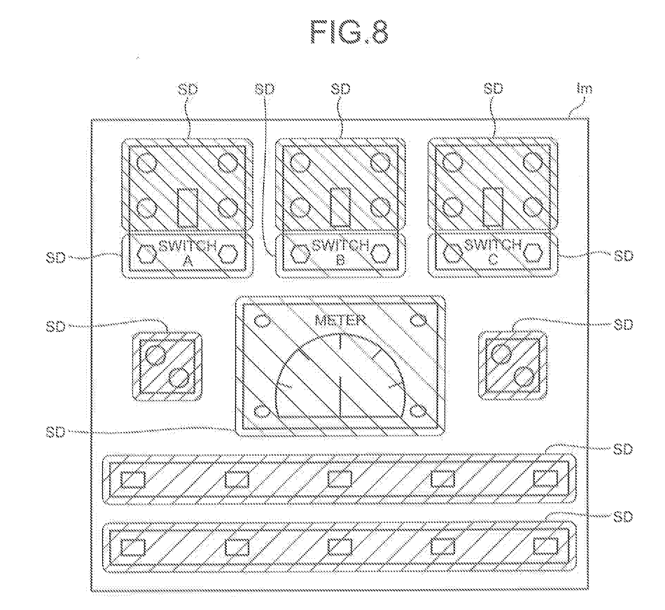

FIG. 8 is a diagram illustrating a display example of the segment display information SD in a case where the work segment generating unit 61 generates the work segments using “work object” and “part to be used” or “tool to be used” out of the attributes of the work elements.

To generate the work segments using “work object” and “part to be used” or “tool to be used”, the work segment generating unit 61 classifies the work elements such that work elements having the same “work object” and the same “part to be used” or “tool to be used” belong to one work segment, thereby generating the work segments.

The label assigning unit 62 assigns labels based on the similarity between the work segments to the work segments generated using “work object” and “part to be used” or “tool to be used”. In other words, the label assigning unit 62 assigns a common label to similar work segments. The similarity is determined by a method of determining work segments including work elements having similar “work object” and the same “part to be used” or “tool to be used” to the similar work segments, for example.

As illustrated in FIG. 8, for example, the display control unit 63 superimposes the segment display information SD corresponding to the work segments generated by the work segment generating unit 61 on the drawing data, thereby generating the display image Im. The display control unit 63 performs control such that the display device 30 displays the display image Im. The segment display information SD superimposed on the drawing data enables the worker to recognize one difference between the labels by the difference in color, for example.

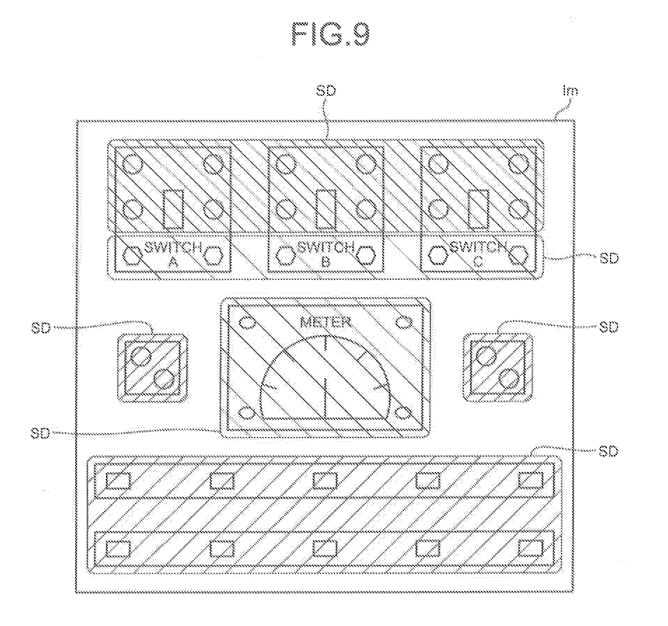

FIG. 9 is a diagram illustrating a display example of the segment display information SD in a case where the work segment generating unit 61 generates the work segments using “work position” and “part to be used” or “tool to be used” out of the attributes of the work elements.

To generate the work segments using “work position” and “part to be used” or “tool to be used”, the work segment generating unit 61 classifies the work elements such that work elements having “work position” close to each other and the same “part to be used” or “tool to be used” belong to one work segment, thereby generating the work segments.

The label assigning unit 62 assigns labels based on the similarity between the work segments to the work segments generated using “work position” and “part to be used” or “tool to be used”. In other words, the label assigning unit 62 assigns a common label to similar work segments. The similarity is determined by a method of determining work segments including work elements having similar “work object” and the same “part to be used” or “tool to be used” to the similar work segments, for example.

As illustrated in FIG. 9, for example, the display control unit 63 superimposes the segment display information SD corresponding to the work segments generated by the work segment generating unit 61 on the drawing data, thereby generating the display image Im. The display control unit 63 performs control such that the display device 30 displays the display image Im. The segment display information SD superimposed on the drawing data enables the worker to recognize the difference between the labels by the difference in color, for example.

In a case where “part to be used” or “tool to be used” is used to generate the work segments and assign the labels, the worker who refers to the segment display information SD can select work so as to reduce the number of times he/she changes the tools. Consequently, work load can be reduced.

As described above, the work support device 100A according to the present embodiment classifies a plurality of work elements in a predetermined work area based on the attributes, thereby generating a plurality of work segments each including one or more work elements. The work support device 100A assigns labels based on the similarity between the work segments to the generated work segments. The work support device 100A displays the segment display information SD corresponding to the work segments in a form that enables the worker to recognize the difference between the labels. The work support device 100A according to the present embodiment thus enables the worker who refers to the segment display information SD to grasp the groups that facilitate the work while grasping the entire picture of the work. Consequently, the work support device 100A can appropriately support the work performed by the worker, thereby increasing the efficiency of the work.

### Modification of the First Embodiment

The first embodiment has described generation of the work segments using some attributes of the work elements on the assumption that the attributes of the work elements used to generate the work segments are determined in advance. Alternatively, the attributes of the work elements used to generate the work segments may be selected by the worker.

FIG. 10 is a block diagram illustrating an exemplary configuration of a work support device 100A′ according to a modification of the first embodiment. The work support device 100A′ according to the present modification is obtained by adding an attribute specification receiving unit 64 to the configuration of the work support device 100A illustrated in FIG. 1. The attribute specification receiving unit 64 is a functional component provided by the processor in the processing circuitry 60 executing the computer programs, for example. The attribute specification receiving unit 64 receives an operation of specifying attributes performed by the worker.

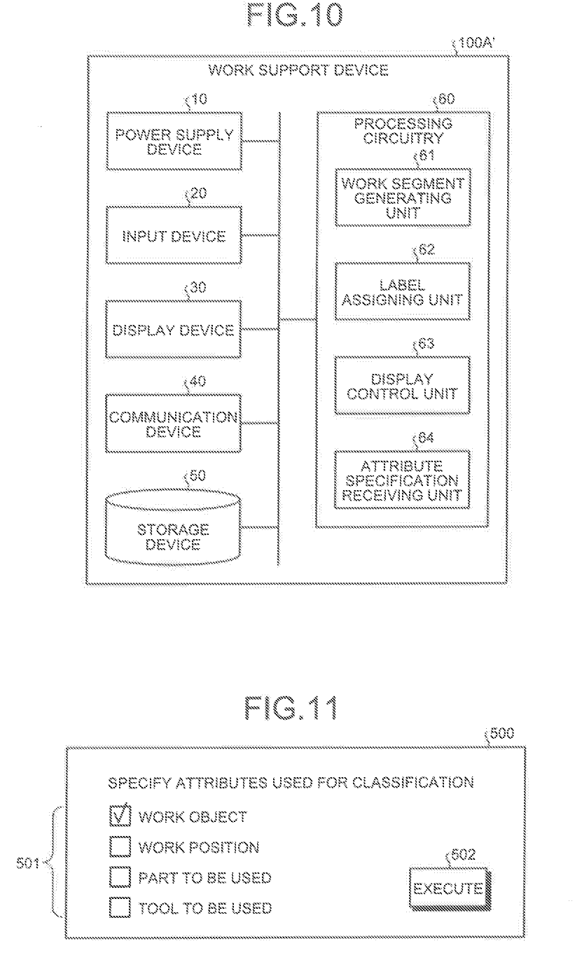

The attribute specification receiving unit 64 causes the display device 30 to display a selection screen 500 illustrated in FIG. 11, for example. The selection screen 500 has check boxes 501 and an “execute” button 502. The check boxes 501 are used to specify attributes of the work elements used to generate the work segments. If the worker performs an operation of checking one of the check boxes 501 corresponding to a desired attribute and tapping the “execute” button 502 on the selection screen 500, the attribute specification receiving unit 64 receives the operation of specifying the attribute performed by the worker. The attribute specification receiving unit 64 transmits the attribute specified by the worker to the work segment generating unit 61 and requests the work segment generating unit 61 to generate the work segments.

The work segment generating unit 61 receives the request from the attribute specification receiving unit 64. The work segment generating unit 61 classifies a plurality of work elements in a predetermined work area based on the attribute specified by the worker, thereby generating a plurality of work segments each including one or more work elements.

As described above, the present modification enables the worker to select the attributes of the work elements used to generate the work segments. With this configuration, the present modification can generate the work segments by a method desired by the worker. Consequently, the worker who refers to the segment display information SD corresponding to the generated work segments can grasp the groups of work in accordance with the standards that seem to facilitate the work while grasping the entire picture of the work.

### Second Embodiment

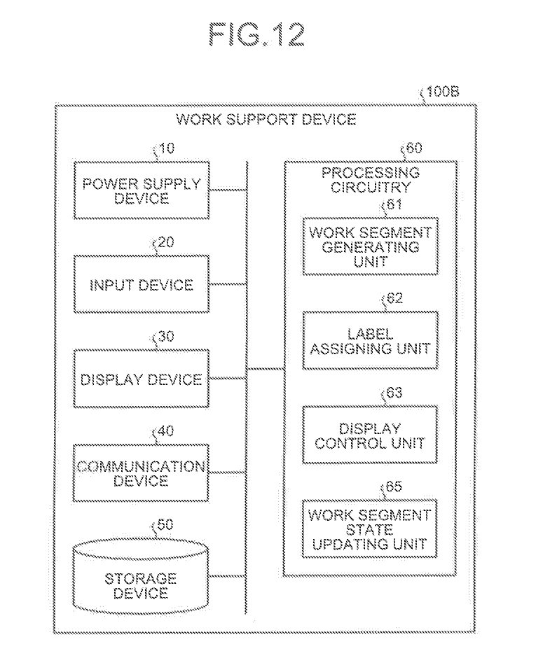

FIG. 12 is a block diagram illustrating an exemplary configuration of a work support device 100B according to a second embodiment. The work support device 100B according to the present embodiment is obtained by adding a work segment stats updating unit 65 to the configuration of the work support device 100A according to the first embodiment illustrated in FIG. 1. The work segment state updating unit 65 is a functional component provided by the processor in the processing circuitry 60 executing the computer programs, for example. The work segment state updating unit 65 updates the state of the work segment generated by the work segment generating unit 61.

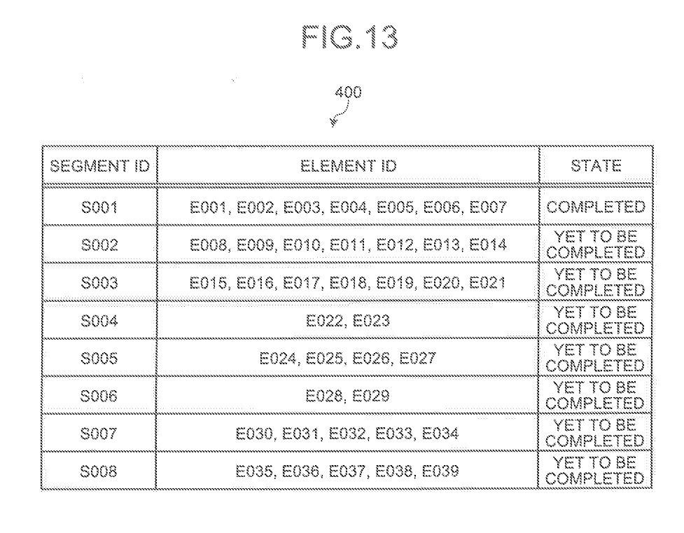

The state of the work segment indicates whether the work for the work segment (work of the work elements included in the work segment) is completed or yet to be completed. The state of the work segment may be managed on the work segment data 400, for example. FIG. 13 illustrates an example of the work segment data 400 in this case. The work segment data 400 illustrated in FIG. 13 holds not only the segment IDs of the work segments generated by the work segment generating unit 61 and the element IDs of the work elements included in the work segments but also “state” indicating whether the work for the work segments is completed or yet to be completed.

If the work segment generating unit 61 generates the work segments and stores the work segment data 400 in the storage device 50, for example, the work segment state updating unit 65 sets the states of the respective work segments to “yet to be completed”. If work for any one of the work segments is completed, and the worker inputs the fact that the work is completed using the input device 20, the work segment state updating unit 65 updates the state of the work segment for which the work is completed from “yet to be completed” to “completed” out of the states of the respective work segments held in the work segment data 400.

The work support device 100B according to she present embodiment, for example, is provided as a function of a mobile electronic device, such as a tablet computer and a smartphone. The input device 20 corresponds to a touch panel that receives touch operations performed on the screen of the display device 30. The worker taps the segment display information SD corresponding to the work segment for which the work is completed out of the segment display information SD displayed on the display device 30, thereby inputting the fact that the work for the work segment is completed. The work segment state updating unit 65 updates the state of the work segment corresponding to the tapped segment display information SD from “yet to be completed” to “completed”.

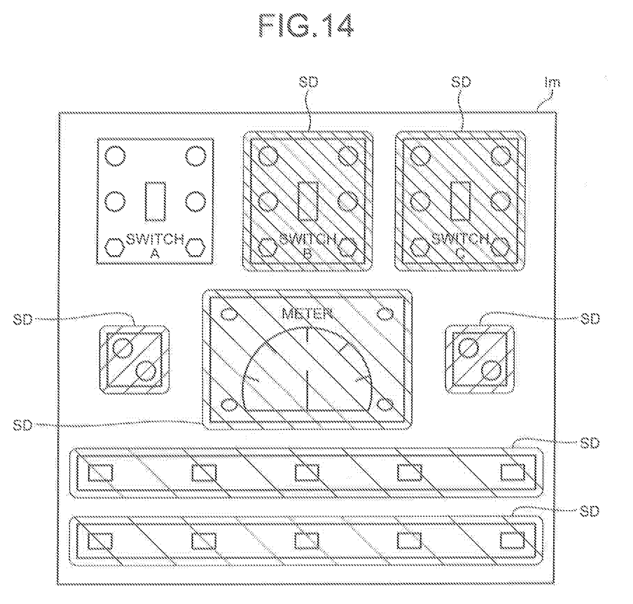

The display control unit 63 according to the present embodiment changes display of the segment display information SD depending on the states of the work segments. The display control unit 63, for example, changes display of the segment display information SD corresponding to the work segment of which the state is changed from “yet to be completed” to “completed” into display indicating “completed”. In a case where the segment display information SD is displayed using the figures illustrated in FIG. 6, for example, the display indicating “completed” is deletion of a figure corresponding to the work segment for which the work is completed (work segment relating to the switch A in this example) as illustrated in FIG. 14. Alternatively, the display control unit 63 may change the display color of the segment display information SD corresponding to the work segment for which the work is completed into color indicating “completed”. Still alternatively, the display control unit 63 may add a character, such as “finished”, or a symbol to the segment display information SD corresponding to the work segment for which the work is completed. In a case where the segment display information SD is superimposed and displayed on the work element data 300 illustrated in FIG. 3, for example, the display control unit 63 may paint out in black the items of the work elements belonging to the work segment for which the work is completed. Alternatively, the display control unit 63 may delete the items of the work elements belonging to the work segment for which the work is completed from the work element data 300.

The states of the work segments are not limited to “yet to be completed” and “completed” and may include “work in progress” and “percentage of completion of work (what percentage of the work elements in the work segment is completed”. Also in this case, the work segment state updating unit 65 updates the stares of the work segments based on the input operation performed by the worker. The display control unit 63 changes display of the segment display information SD depending on the states of the work segments.

Let as assume a case where the states of the work segments include “work in progress”, for example. If the worker taps a figure of the segment display information SD corresponding to a work segment to be performed before starting the work, the color of the figure changes into a color indicating “work in progress”; and if the worker taps the figure after completing the work, the figure is deleted to indicate “completed”. The state of “work in progress” may be represented not only by a change in color but also by blinking or a change in luminance of the figure of the segment display information SD, for example. Alternatively, the segment display information SD may include a “work start” button and a “work completion” button. The worker presses these buttons, thereby changing the states.

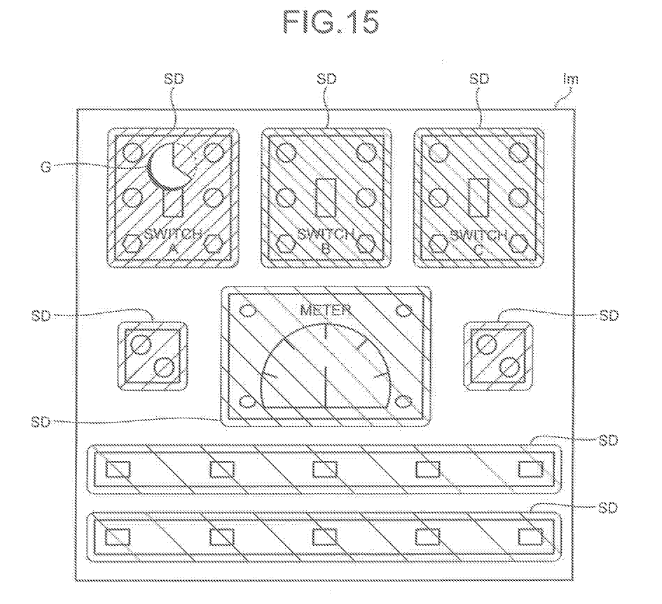

In a case where the states of the work segments include “percentage of completion of work”, the “percentage of completion of work” is calculated using the number of work elements included in the work segments. The worker, for example, taps the segment display information SD every time he/she completes work of one work element in a certain work segment, thereby specifying the number of completed work elements. The work segment state updating unit 65 calculates the “percentage of completion of work” by: Number of completed work elements/Total number of work elements in the work segment×100%, for example. In this case, as illustrated in FIG. 15, for example, the display control unit 63 displays the target segment display information SD in the color indicating “work in progress” and displays a graph G indicating the “percentage of completion of work” on the segment display information SD. The display indicating the “percentage of completion of work” is not limited to the graph G illustrated in FIG. 15 and may be a numerical value, for example. Alternatively, marks may be provided on the respective work elements in the work segment. The worker taps a mark, thereby inputting completion of the work element.

Let us assume a case where the states of the work segments include “work in progress” and “percentage of completion of work”. The display control unit 63 may perform control so as to highlight, when the state of a certain work segment is changed into “completed”, the segment display information SD of another work segment similar to the work segment, that is, another work segment having a label common to the work segment for which the work is completed by a certain method, such as blinking. The highlighting of the segment display information SD can assist the worker in selecting the next work segment. The method for highlighting the segment display information SD is not limited to blinking and may be another method, such as increasing the luminance of the target segment display information SD. If there is no other work segment having a label common to the work segment for which the work is completed, for example, the display control unit 63 may highlight the segment display information SD of another work segment near the work segment for which the work is completed.

If there is an order between the work segments, the work segment generating unit 61 may allocate the order to the work segments that need to be performed in order when generating the work segments. The display control unit 63 may perform control so as to prevent, until work for a work segment to be performed earlier is completed, display of the segment display information SD of work segments to be performed subsequently thereto. In the case of work of fixing wiring and then screwing a lid, for example, a work segment including fixing of wiring is to be performed earlier, and a work segment including screwing of the lid is to be performed next. In this case, the display control unit 63 performs control so as to prevent display of the segment display information SD of the work segment including screwing of the lid until the state of the work segment including fixing of wiring is changed into “completed”. If the display control unit 63 displays only specific segment display information SD, however, the worker may possibly fail to grasp the entire picture of the work. To address this, the display control unit 63 may display the segment display information SD corresponding to all the work segments first. Subsequently, when the worker presses a button or slides a screen, the display control unit 63 may perform display control on the segment display information SD based on the order of the work.

As described above, the work support device 100B according to the present embodiment changes display of the segment display information SD depending on the states of the work segments. Consequently, the present embodiment enables the worker to grasp the groups that facilitate the work while grasping the entire picture of the work similarly to the first embodiment. In addition, the present embodiment enables the worker to grasp how much the work proceeds.

### Modification of the Second Embodiment

The second embodiment determines the states of the work segments based on the input operation performed by the worker. Alternatively, the work support device may estimate the work segment for which the work is performed by the worker and the state thereof using images of the work area taken by a camera, for example, thereby automatically updating the state of the work segment.

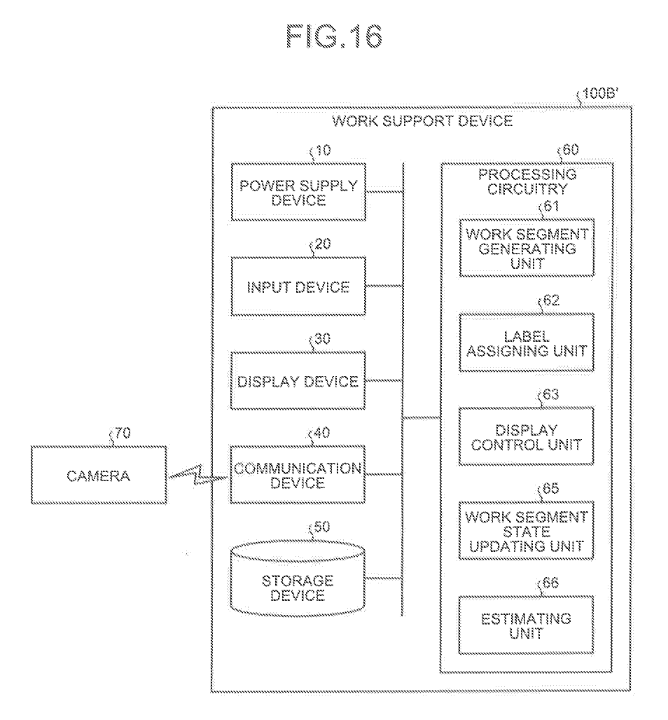

FIG. 16 is a block diagram illustrating an exemplary configuration of a work support device 100B′ according to a modification of the second embodiment. The work support device 100B′ according to the present modification is obtained by adding a camera 70 and an estimating unit 66 to the configuration of the work support device 100B illustrated in FIG. 12. The camera 70 takes images (video or consecutive still images) of the work area WA. The estimating unit 66 is a functional component provided by the processor in the processing circuitry 60 executing the computer programs, for example. The estimating unit 66 estimates the work segment for which the work is being performed by the worker and the state thereof based on the image taken by the camera 70.

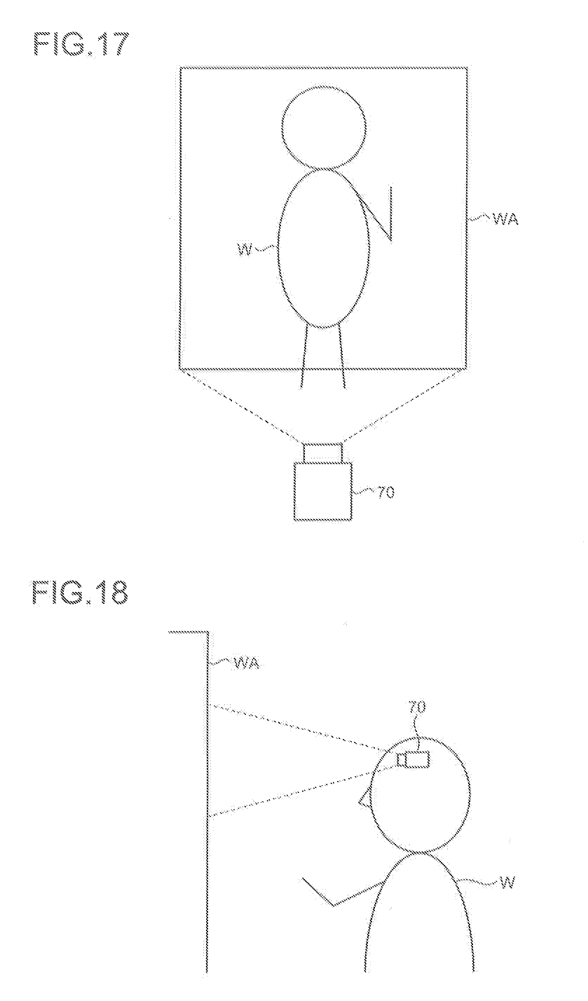

FIG. 17 is a diagram illustrating an arrangement example of the camera 70 that captures the work area WA. In the example illustrated in FIG. 17, the camera 70 is arranged behind a worker W and takes images including the entire area of the work area WA and the worker W. The images taken by the camera 70 are sequentially received by the processing circuitry 60 via the communication device 40.

The worker W stands straight in front of the work area WA before starting work. The estimating unit 66 recognizes the work area WA and the head, the shoulders, the elbows, and the hands of the worker W from an image taken by the camera 70 at this time. The estimating unit 66 thus estimates the outer shape of the work area WA and the skeleton model of the upper half of the body of the worker W. If the worker W is included in the images transmitted from the camera 70, the estimating unit 66 estimates the positions of the fingertips with respect to the head of the worker W using the estimated skeleton model of the worker W. The estimating unit 66 estimates near which work segment in the work area WA the fingertips of the worker W are placed based on the positional relation between the outer shape of the work area WA and the position of the head of the worker W. If the fingertips of the worker W continue to stay at an “yet to be completed” work segment for a predetermined period of time or longer, the estimating unit 66 determines that the worker W is performing work for the work segment and estimates the state of the work segment to be “work in progress”.

If the fingertips of the worker W is apart from the “yet to be completed” work segment for a predetermined period of time or longer, the estimating unit 66 determines that the work for the work segment in the state of “work in progress” is completed and changes the state of the work segment into “completed”. While the predetermined period of time is 30 seconds, for example, it may be another value depending on the proficiency of the worker W, the production sites, or other factors.

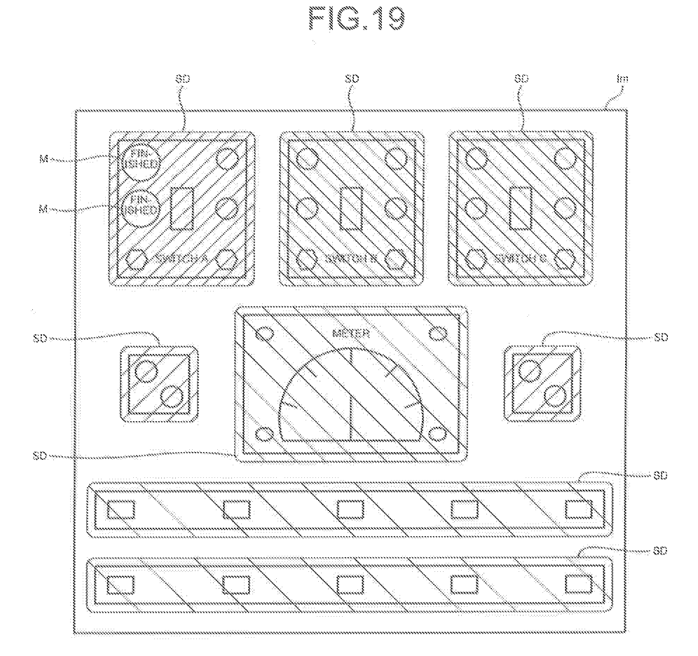

The camera 70 may take images of a partial area in the work area WA to which the worker W pays attention. FIG. 18 is a diagram of an arrangement example of the camera 70 in this case and illustrates an example where the worker W wears the camera 70, which is a small charge-coupled device (CCD) camera. In the example illustrated in FIG. 18, the camera 70 is sewn on a work cap worn by the worker W or attached to the frame of glasses worn by the worker W. The camera 70 is thus fixed on the head of the worker W to take images of a partial area to which the worker W pays attention in the work area WA.

The worker W stands a little away from the work area WA before starting work such that the angle of view of the camera 70 covers the entire area of the work area WA. The camera 70 takes an image of the entire area of the work area WA. The image of the entire area of the work area WA taken by the camera 70 is stored in the storage device 50 or a memory in the processing circuitry 60, for example, via the communication device 40. Subsequently, if the worker W moves closer to the work area WA and starts the work, the camera 70 takes images of a partial area to which the worker W pays attention in the work area WA. The images are sequentially received by the processing circuitry 60 via the communication device 40.

The estimating unit 66 compares the images sequentially received from the camera 70 with the image of the entire area of the work area WA stored in advance, thereby estimating a work segment in the area to which the worker W pays attention. If the state of the work segment is “yet to be completed”, and the work segment is continuously included in the images received from the camera 70 for a predetermined period of time or longer, the estimating unit 66 estimates the state of the work segment to be “work in progress”. If the work segment in the state of “work in progress” is not continuously included in the images received from the camera 70 for a predetermined period of time or longer, the estimating unit 66 determines that the work for the work segment is completed and changes the state of the work segment into “completed”. While the predetermined period of time is 30 seconds, for example, it may be another value depending on the proficiency of the worker W, the production sites, or other factors.

In a case where the small CCD camera illustrated in FIG. 18 is used as the camera 70 to take images of the area to which the worker W pays attention in the work area WA, the work support device 100B′ may take images of parts or tools to be used in the work area WA in advance and store them in the storage device 50. With this mechanism, the estimating unit 66 can estimate the “percentage of completion of work”. The estimating unit 66, for example, compares the images sequentially received from the camera 70 with the images of the parts or the tools used in the work area WA, thereby specifying a part or a tool being used by the worker W. If a single part or a single tool is continuously included in the images received from the camera 70, the estimating unit 66 determines that the worker W continues to perform work that requires the part or the tool. If the part or the tool is not included in the images received from the camera 70, the estimating unit 66 determines that the work that requires the part or the tool is completed. The estimating unit 66 derives in advance the types and the number of times of use of the parts or the tools based on the attributes of the work elements included in the work segments. Based on the number of times the target part or the target tool is used, the estimating unit 66 calculates the “percentage of completion of work”. Let us assume a case where the work elements in a certain work segment are “screw tightening (part: screw A)” performed twice, and “screw B tightening (part: set screw B)” performed once, for example. If the screw A is used once and the set screw B is used once for the work segment, the “percentage of completion of work” of the work segment is calculated to be ⅔=67%.

The estimating unit 66 may compare the images sequentially received from the camera 70 with the image of the entire area of the work area WA stored in advance, thereby estimating a work element the work of which is being performed by the worker W in the work segment in the state of “work in progress”. In this case, the display control unit 63 may display the segment display information SD indicating whether the work is completed for each work element in the work segment like placement of a “finished” mark M at the position of the work element the work of which is completed as illustrated in FIG. 19, for example. While the work support device 100B′ causes the worker W to recognize the work element the work of which is completed using the “finished” mark M in the example illustrated in FIG. 19, the present invention is not limited thereto. The work support device 100B′ may cause the worker W to recognize the work element the work of which is completed using characters, symbols, or figures, for example.

As described above, the present modification estimates the work segment for which the work is performed by the worker W and the state thereof using the images taken by the camera 70, thereby automatically updating the state of the work segment. Consequently, the present modification can reduce operating load of the worker W.

### Third Embodiment

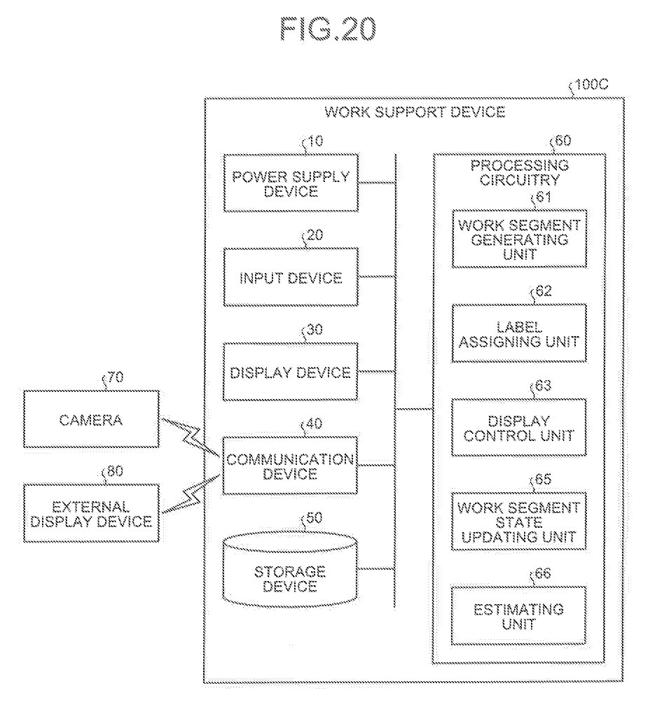

FIG. 20 is a block diagram illustrating an exemplary configuration of a work support device 100C according to a third embodiment. The first and the second embodiments and the modifications thereof cause the internal display device 30 to display the segment display information SD. The present embodiment transmits the segment display information SD generated by the display control unit 63 to an external display device 80 via the communication device 40 and causes the external display device 80 to display the segment display information SD. Examples of the external display device 80 include, but are not limited to, a projector, an eyeglass-type display, etc.

In a case where a projector is used as the external display device 80, the projection position of the projector is adjusted to the work area WA in advance. The projector superimposes and displays the segment display information SD on the work area WA by projection mapping. In this case, the display control unit 63 preferably changes display of the segment display information SD depending on whether the worker W is performing work. The estimating unit 66, for example, estimates whether the worker W is performing work based on the images received from the camera 70. The display control unit 63 performs control as follows: if the worker W is not performing work, the external display device 80 displays the segment display information SD; whereas, if the worker W is performing work, the external display device 80 stops displaying the segment display information SD so as to prevent the segment display information SD from obstructing the work. The estimating unit 66 may estimate the work segment for which the work is being performed based on the images received from the camera 70. The display control unit 63 may perform control such that the external display device 80 stops displaying only the segment display information SD of the work segment for which the work is being performed and displays only the segment display information SD of the work segment in the state of “yet to be completed”.

In a case where an eyeglass-type display is used as the external display device 80, the small CCD camera illustrated in FIG. 18, for example, is used as the camera 70, and the estimating unit 66 estimates the work segment the area to which the worker W pays attention in the work area WA by the method described above. The display control unit 63 causes the eyeglass-type display to display the segment display information SD corresponding to the work segment estimated by the estimating unit 66.

As described above, the work support device 100C according to the present embodiment causes the external display device 80, such as a projector and an eyeglass-type display, to display the segment display information SD. Consequently, the present embodiment enables the worker W to grasp the entire picture of the work and the groups that facilitate the work more intuitively.

### Supplementary Explanation

While the work support device according to the embodiments above and the modifications thereof is provided as a function of a mobile electronic device, such as a tablet computer and a smartphone, used by the worker, for example, it may be provided by a server device connected to such a mobile electronic device via a network. In this case, the server device includes the work segment generating unit 61, the label assigning unit 62, the display control unit 63, the attribute specification receiving unit 64, the work segment state updating unit 65, and the estimating unit 66, for example. The server device causes the mobile electronic device used by the worker to display the segment display information.

The units constituting the work support device (the work segment generating unit 61, the label assigning unit 62, the display control unit 63, the attribute specification receiving unit 64, the work segment state updating unit 65, and the estimating unit 66) can be provided by one or a plurality of processors executing the computer programs, that is, by software, for example. Alternatively, the units described above may be provided by a processor, such as a dedicated integrated circuit (IC), that is, by hardware. Still alternatively, the units described above may be provided by a combination of software and hardware. In a case where a plurality of processors are used, the processors may each provide one of the units described above or two or more of them.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. A work support device comprising:
a memory; and
processing circuitry configured to function as:
a work segment generating unit configured to generate a plurality of work segments including one or more work elements out of a plurality of work elements classified based on any one or a plurality of attributes of a work object, a work position, a part to be used, or a tool to be used; and
a display control unit configured to control display of segment display information corresponding to the work segments.

2. The device according to claim 1, wherein the processing circuitry is further configured to function as:
a label assigning unit configured to assign labels to the respective work segments, wherein
the display control unit performs control so as to display the segment display information that makes difference between the labels recognizable.

3. The device according to claim 2, wherein
the label assigning unit determines similarity between the work segments based on the attributes of the work elements included in the work segments and assigns a common label to similar work segments.

4. The device according to claim 3, wherein
the work segment generating unit classifies the work elements based on at least the work object out of the attributes to generate the work segments, and
the label assigning unit determines, among the generated work segments, the work segments at least the work object of which is similar to be the similar work segments, and assigns the common label to the similar work segments.

5. The device according to claim 4, wherein
the work segment generating unit classifies the work elements based on the work object and the part to be used or the tool to be used, out of one attributes to generate the work segments, and
the label assigning unit determines, among the generated work segments, the work segments the work object of which is similar and having the same part to be used or the same tool to be used to be the similar work segments and assigns the common label to the similar work segments.

6. The device according to claim 3, wherein
the work segment generating unit classifies the work elements based on at least the work position out of the attributes to generate the work segments, and
the label assigning unit determines, among the generated work segments, the work segments having at least the same part to be used or the same tool to be used to be the similar work segments and assigns the common label to the similar work segments.

7. The device according to claim 1, wherein the processing circuitry is further configured to function as:
an attribute specification receiving unit configured to receive an operation of specifying at least one of the attributes, wherein
the work segment generating unit classifies the work elements based on the specified attributes to generate the work segments.

8. The device according to claim 1, wherein
the display control unit changes display of the segment display information corresponding to the work segments depending on a state of the work segments.

9. The device according to claim 8, wherein
when work for any one of the work segments is completed, the display control unit changes display of the segment display information corresponding to another work segment that is similar to or positioned near the work segment for which the work is completed so as to highlight the another work segment.

10. The device according to claim 8, wherein the processing circuitry is further configured to function as:
an image-capturing unit configured to take an image of a work area including a worker or an image of a partial area in the work area to which the worker pays attention; and
an estimating unit configured to estimate a work segment for which work is performed by the worker out of the work segments and the state of the work segment based on the image taken by the image-capturing unit, wherein
the display control unit changes display of the segment display information corresponding to the work segment depending on the state of the work segment estimated by the estimating unit.

11. The device according to claim 10, wherein
the estimating unit estimates whether the worker is performing work based on the image taken by the image-capturing unit, and
the display control unit changes display of the segment display information depending on whether the worker is performing work.

12. A work support method comprising:
generating a plurality of work segments including one or more work elements out of a plurality of work elements classified based on any one or a plurality of attributes of a work object, a work position, a part to be used, or a tool to be used; and
controlling display of segment display information corresponding to the work segments.

13. The method according to claim 12, further comprising:
assigning, before performing the controlling, labels to the respective work segments, wherein
the controlling performs control so as to display the segment display information that makes difference between the labels recognizable.

14. The method according to claim 13, wherein
the assigning determines similarity between the work segments based on the attributes of the work elements included in the work segments and assigns a common label to similar work segments.

15. The method according to claim 14, wherein
the generating classifies the work elements based on at least the work object out of the attributes to generate the work segments, and
the assigning determines, among the generated work segments, the work segments at least the work object of which is similar to be the similar work segments, and assigns the common label to the similar work segments.

16. The method according to claim 15, wherein
the generating classifies the work elements based on the work object and the part to be used or the tool to be used, out of the attributes to generate the work segments, and
the assigning determines, among the generated work segments, the work segments the work object of which is similar and having the same part to be used or the same tool to be used to be the similar work segments and assigns the common label to the similar work segments.

17. The method according to claim 14, wherein
the generating classifies the work elements based on at least the work position out of the attributes to generate the work segments, and
the assigning determines, among the generated work segments, the work segments having at least the same part to be used or the same tool to be used to be the similar work segments and assigns the common label to the similar work segments.

18. The method according to claim 12, further comprising:
receiving, before performing the generating, an operation of specifying at least one of the attributes, wherein
the generating classifies the work elements based on the specified attributes to generate the work segments.

19. The method according to claim 12, wherein
the controlling changes display of the segment display information corresponding to the work segments depending on a state of the work segments.

20. A computer program product having a non-transitory computer readable medium including programmed instructions, wherein the instructions, when executed by a computer, cause the computer to perform:
a function of generating a plurality of work segments including one or more work elements out of a plurality of work elements classified based on any one or a plurality of attributes of a work object, a work position, a part to be used, or a tool to be used; and
a function of controlling display of segment display information corresponding to the work segments.
